(19) United States
(12) Patent Application Publication
(10) Pub. No.: US 2010/0194510 A1
(43) Pub. Date: Aug. 5, 2010

(54) Inductive Electrical Device

(76) Inventor: Klemens Pruegl, Regensburg (DE)

Correspondence Address: SLATER & MATSIL LLP, 17950 PRESTON ROAD, SUITE 1000, DALLAS, TX, 75252, US

(21) Appl. No.: 12/364,129

(22) Filed: Feb. 2, 2009

(51) Int. Cl. H01F 27/28; H01F 7/06

(52) U.S. Cl. 336/73; 29/602.1

(57) ABSTRACT

An inductive electrical device according to an embodiment of the present invention including a core structure, wherein the core structure includes a synthetic antiferromagnet is disclosed.

### BACKGROUND

Electrical circuits typically comprise electrical or electronic components, which may be roughly divided into active components and passive components. The group of passive components comprises, for instance, resistors, capacitors, and inductive electrical devices, such as inductors or transformers.

Due to the ever present tendency of reducing structural sizes, electrical circuits are often completely or partially realized based on integrated circuits (IC). Many physical and electrical properties of electrical and electronic components depend on length, width and other dimensions or dimension-related quantities such as volumes or areas. As a consequence, miniaturizing affects not only the relevant electrical circuits in terms of their size, but also the electrical and electronic components comprised thereof may also be affected in terms of an availability of electrical and electronic components with desired, requested or required electrical and other physical quantities.

Moreover, miniaturizing electrical and electronic components may further impose restraints due to the availability of process techniques, materials and other fabrications-related parameters and circumstances. This may lead, for instance, to an alteration of available electrical quantities and related quantities in the case of integrating such electrical or electronic components compared to corresponding discrete components.

While many active electrical and electronic components can be implemented very well in the framework of integrated circuits, passive electrical and electronic components may therefore pose additional challenges when implementing these components into integrated circuits. Examples of these electrical devices comprise, for instance, inductive electrical devices, as the previously mentioned inductors or transformers, which may suffer from reduced inductivity values, quality factors (Q factors) or other electrical and physical properties when implementing these in integrated circuits.

### BRIEF DESCRIPTION OF THE DRAWINGS

Embodiments according to the present invention will be described hereinafter making reference to the following drawings.

FIG. 1a shows a top view of an inductive electrical device according to an embodiment of the present invention;

FIGS. 1b and 1c show cross-sectional views of the inductor along lines shown in FIG. 1a;

FIG. 2 shows a cross-sectional view of a synthetic antiferromagnet according to an embodiment of the present invention;

FIG. 3 illustrates magnetization processes in the case of the synthetic antiferromagnet shown in FIG. 2;

FIG. 4 shows a cross-sectional view of a synthetic antiferromagnet according to a further embodiment of the present invention;

FIG. 5a shows a cross-sectional view of an inductor according to an embodiment of the present invention;

FIG. 5b shows a top view of the inductor according to an embodiment of the present invention shown in FIG. 5a;

FIG. 6a shows a top view of a transformer according to an embodiment of the present invention;

FIGS. 6b and 6c show cross-sectional views of the transformer shown in FIG. 6a along two lines indicated in FIG. 6a;

FIG. 7a shows a top view of a further transformer according to an embodiment of the present invention;

FIGS. 7b and 7c show cross-sectional views of the transformer according to an embodiment of the present invention shown in FIG. 7a; and

FIG. 8 shows a cross-sectional view of an integrated circuit comprising an inductive electrical device according to an embodiment of the present invention.

### DETAILED DESCRIPTION OF ILLUSTRATIVE EMBODIMENTS

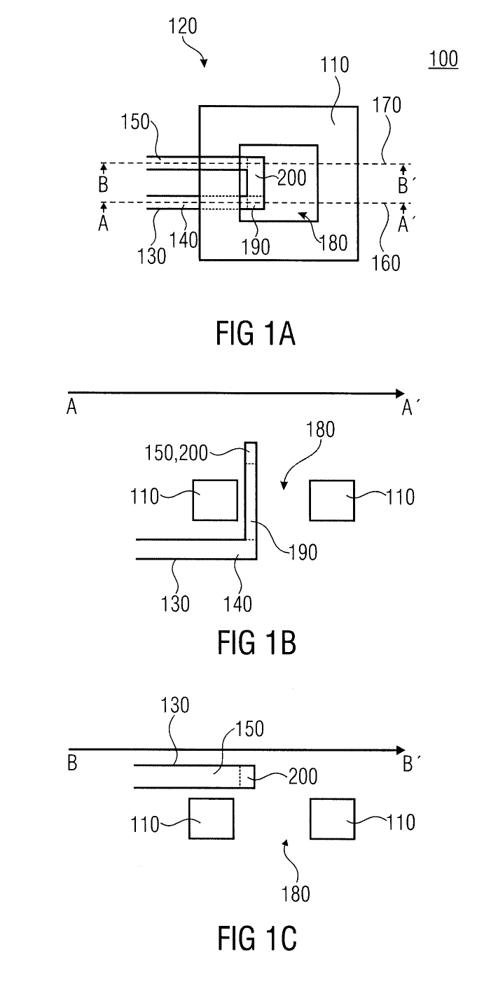

With reference to FIGS. 1a to 8, embodiments according to the present invention will be discussed in more detail.

In the design and implementation of electrical circuits among the previously mentioned passive components, inductive electrical devices such as inductors and transformers play an important role in resonant circuits, tune circuits, RLC-circuits (R=resistance of a resistor, L=inductivity of an inductor or transformer, C=capacitance of a capacitor), or other oscillatory circuits, to name but a few. Further examples for oscillatory circuits comprise filters and other circuits employing the complex impedance of an inductor or, in general, of an inductive electrical device. In the case of power supply circuits, also inductive electrical devices are employed, for instance, as transformers, since transformers allow an easy and efficient adaptation of an amplitude value of a voltage or another electrical quantity.

However, as outlined above, when implementing, designing and fabricating circuits based on integrated circuits, additional challenges and demands may be imposed on the circuit designer, due to the availability of electrical devices with required electrical quantities. Moreover, especially in the case of highly integrated circuits, additional constraints imposed on the designer, such as available space, costs, and other fabrication-related and operation-related circumstances, may become important.

For conductive electrical devices, such as the previously mentioned inductors and transformers, ferromagnetic cores or ferromagnetic core structures may, in principle, be formed by different (thin film) deposition processes, such as physical vapor deposition (PVD; e.g., sputtering deposition) and electro-plating, to name but a few. When such a core or core structure is subjected to an alternating magnetic field, the core structure will periodically be re-magnetized, switching an orientation of the magnetization of domains.

In the case of ferromagnetic core structures, the domain walls of the magnetic domains present in the ferromagnetic material will be moved accordingly. This moving of the domain walls is typically not a continuous process, but happens in leaps. As a consequence, this leads to a dramatic reduction of the quality factor or Q factor of the inductor or coil.

In this context, it should be noted that in physics and engineering the quality factor or Q factor is a dimensionless parameter that compares the time constant for a decay of an oscillating physical systems amplitude to its oscillation period. Equivalently expressed, the quality factor compares the frequency at which the system oscillates to the rate at which it dissipates energy.

In the case of an inductive electrical device, employing a ferromagnetic core or core structure may lead to a significant loss of energy which is most probably dissipated as heat, due to the domain walls moving in leaps when being re-magnetized.

As a consequence, a demand exists for an inductive electrical device with an improved quality factor, which may be implemented in the framework of an integrated circuit. Hence, a demand exists to fabricate and to implement an inductive electrical device, an inductor, a transformer, and an integrated circuit based on a core structure or a magnetic core structure for an inductor or coil and a transformer, which is re-magnetized by turning the magnetization instead of forming, generating, and altering magnetic domains.

As will be outlined below in more detail, employing an antiferromagnet as a core or core structure or a part thereof for an inductive electrical device, such as an inductor or a transformer, may lead to a virtually domain-free “ferromagnet” for an inductor, coil, transformer, or similar inductive electrical device. However, before going into more detail concerning the internal structures of synthetic antiferromagnets and their behavior concerning magnetization processes, first an embodiment according to the present invention, in the form of an inductive electrical device will be described in more detail.

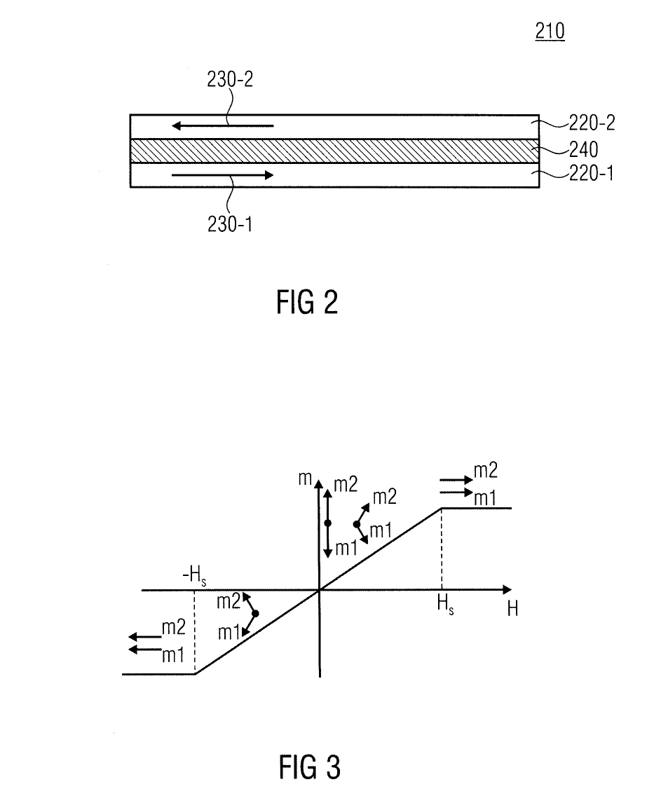

FIG. 1a shows a top view of an inductive electrical device 100 according to an embodiment of the present invention comprising a core structure 110, which comprises a synthetic antiferromagnet. In many embodiments, the core structure 110 may equally well be referred to as core 110. The term synthetic antiferromagnet (SAF) refers to a typically layered structure which comprises typically at least two different magnetizations which are aligned in an anti-parallel manner, when no external magnetic field is present. The term synthetic antiferromagnet points to the fact that this antiferromagnet structure is based on an artificially or synthetically created structure compared to a single compound material exhibiting antiferromagnetism. In most cases the term synthetic antiferromagnet, synthetic antiferromagnetic material and synthetic antiferromagnetic component may synonymously used. However, more details concerning possible implementations of synthetic antiferromagnets will be given in the context of FIGS. 2 to 4.

The inductive electrical device shown in FIG. 1a is an inductor 120 which comprises an electrically conductive structure 130 forming at least partially a winding around the core structure 110. The conductive structure 130 may in many cases equally well be referred to as a conductor 130. The inductor 120 is formed on the semiconductor substrate which is not labeled as such in FIG. 1a, and realized based on a layered structure, which, for instance, may be fabricated based on standard thin film processes and techniques comprising patterning, etching, deposition, polishing and other thin film process steps. Due to the layered structure of the inductor 120, the conductive structure 130 comprises a first part 140 which is arranged in a first layer. As will be shown in more detail with respect to FIGS. 1b and 1c, the first part 140 extends underneath the core structure 110, which is indicated in FIG. 1a by using dashed lines.

The conductive structure 130 also comprises a second part 150, which is arranged in the second layer being different from the first layer. The second part 150 extends above the core structure 110.

To facilitate a better understanding of the structure of the inductor 120 shown in FIG. 1a, FIGS. 1b and 1c show cross-sectional views along two dashed lines 160, 170 shown in FIG. 1a, respectively. To be more specific, FIG. 1b shows a cross-sectional view along the dashed line 160 which is also labeled in FIG. 1a as line A-A′. Accordingly, FIG. 1c shows the cross-sectional view along the dashed line 170 which is also labeled in FIG. 1a as B-B′.

The core structure 110 comprises a ring-like shape which, in the case of the embodiment shown in FIGS. 1a to 1c, is closed. Therefore, the core structure 110 comprises a central hole 180 so that the first and second parts 140, 150 of the conductive structure 130 may be electrically connected inside the hole 180 by a via 190. In the implementation schematically shown in FIGS. 1a to 1c, the via 190 is arranged on the dashed line 160, while the second part 150 of the conductive structure 130 comprises a horizontally extending section 200 shown in FIG. 1a.

As a consequence, the conductive structure 130 is formed at least partially around the core structure 110 or, in other words, formed to at least partially form a winding around the core structure 110. Depending on the actual thicknesses of the layers involved and the lateral sizes of the core structure 110 and other elements, the conductive structure 130 forms approximately half a winding around the core structure 110.

The inductive electrical device 100 or the inductor 120 further comprises an electrical insulator or insulating structure, which is deposited and formed in between the conductive structure 130 and the core structure 110, to provide electrical insulation of the conductive structure 130 from the core structure 110. For the sake of clarity only, the insulating material has been omitted in FIGS. 1a to 1c.

It should be noted that the insulating material not shown in FIGS. 1a to 1c is an optional component, which is not required to be implemented in different embodiments according to an embodiment of the present invention. For example, when the conductive structure 130 itself comprises an outer shell offering electrical insulation, or when the core structure 110 itself is electrically insulating. Moreover, if in certain applications, electrical insulation is not required between the core structure 110 and the conductive structure 130, then an electrical insulation is not required at all, or is formed due to a choice of materials involved (e.g., forming a Schottky barrier) or other physical effects, an implementation of the insulating material may eventually be omitted. In this case, the conductive structures 130 may be directly in contact with the core structure 110.

Moreover, as the top view of FIG. 1a shows, the core structure 110 is formed to comprise in this plane, a rectangular or quadratic cross-section. Naturally, the core structure 110 may also be implemented based on different geometries, for instance, based on polygonal cross-sections or round cross-sections. Moreover, the core structure 110 may also be implemented in the form of one or more segments, so that the individual segments do not form a closed core structure 110.

Moreover, the core structure 110 is not necessarily required to be closed at all. For instance, it is possible to implement the core structure 110 in the form of a C-shape with a section of the core structure 110 missing, being opposite to the section around which the conductive structure 130 is wound. The core structure 110 may be formed, for instance, by round shapes, rectangular shapes or polygonal shapes. Moreover, in principle, the core structure 110 may also be implemented based on a single bar or a similar structure as well. Naturally, the previous description of open core structures or non-closed core structures 110 is not limited to rectangular, quadratic, or polygonal shapes, but also includes the possibility of implementing rounded shapes, such as a ring, a segment of ring, elliptic shapes, to name but a few.

As outlined before, the challenge of avoiding the generation of magnetic domains may be dealt with by fabricating core structures for inductive electrical devices from a synthetic antiferromagnet (SAF). As briefly outlined before, synthetic antiferromagnets may also be referred to as synthetic antiferromagnetic materials or components, since they comprise artificially fabricated structures.

A synthetic antiferromagnet, which is also sometimes referred to as an artificial antiferromagnet, typically comprises at least two ferromagnetic layers, which are separated by a non-ferromagnetic layer, typically a non-ferromagnetic metal.

FIG. 2 shows a cross-sectional view of a synthetic antiferromagnet 210 comprising a first magnetic layer 220-1 with a magnetization indicated by an arrow 230-1. The synthetic antiferromagnet 210 further comprises a second magnetic layer 220-2 with a second magnetization 230-2 which is aligned in an anti-parallel manner to the first magnetization 230-1 of the first magnetic layer 220-1. The two magnetic layers, 220-1 and 220-2, collectively 220, are separated from one another by a non-magnetic layer 240, which may, for instance, be a non-magnetic metal.

The two magnetic layers 220 may for instance be fabricated from cobalt (Co), nickel (Ni), iron (Fe), cobalt/iron (CoFe), or nickel/iron (NiFe). The non-magnetic layer 240 may for instance comprise ruthenium (Ru) or copper (Cu), to name but a few possible materials on which the magnetic layers 220 and the non-magnetic layer 240 may be based.

As indicated by the arrows, 230-1 and 230-2, collectively 230, in FIG. 2, the magnetizations of the two magnetic layers 220 are aligned in an anti-parallel manner to each other which is the reason for the synthetic antiferromagnets being referred to as antiferromagnets.

To be more specific, the magnetizations 230 of the ferromagnetic layers 220 are magnetically coupled via the non-magnetic layer 240. This magnetic coupling is also referred to as RKKY-interaction, named after Ruderman, Kittel, Kasuya, and Yosida, describing an interaction of magnetic moments mediated by charged carriers contributing to the conductivity of the non-magnetic layer 240 (e.g., free electrons). The strength and orientation of the magnetic interaction oscillates as a function of a thickness of the non-magnetic layer 240.

As a consequence, in the case of specific, typically material dependent thicknesses of the non-magnetic layer 240, the magnetic moments present in the magnetic layers 220 will be aligned in an anti-parallel manner. Therefore, the magnetic layers 220 are typically fabricated from ferromagnetic materials, while the non-magnetic layer 240 typically comprises a metal facilitating a RKKY-interaction or a RKKY-like-interaction. In the case of the magnetic layers 220 being fabricated from cobalt (Co) and the non-magnetic layer 240 being fabricated from copper (Cu), the thickness of the copper layer 240 is approximately 1 nm, which facilitates, for this material combination, a strong antiferromagnet interlayer interaction.

In the case of a synthetic antiferromagnet comprising, for instance, cobalt/iron (CoFe) as material for the magnetic layers 220 and ruthenium (Ru) for the non-magnetic layer 240, a typical thickness of the ruthenium layer is approximately 0.8 nm to facilitate a strong antiferromagnetic interlayer interaction.

If such a synthetic antiferromagnet or synthetic antiferromagnetic material is subjected to no or sufficiently weak magnetic field, the magnetizations 230 of the single magnetic layers 220 are perpendicularly aligned to the external magnetic field at first. To illustrate this, FIG. 3 shows a graph of an overall magnetization m as a function of an externally applied magnetic field H, which also schematically illustrates the orientation of the magnetizations 230 of the two magnetic layers 220 by arrows.

To be more specific, in FIG. 3, the arrows referred to as m1 designate the orientation of the magnetization 230-1 of the first magnetic layer 220-1, whereas the arrows referred to as m2 describes the orientation of the magnetizations 230-2 of the second magnetic layer 220-2.

As indicated in FIG. 3, starting at a very small or vanishing external magnetic field (H=0), the two magnetizations 230 (m1 and m2 in FIG. 3) are aligned in an anti-parallel manner. As a consequence, the overall magnetization m=m1+m2 also vanishes (m=0).

Increasing the external magnetic field (H) leads to a turning of both magnetic moments m1, m2 into the direction of the external magnetic field, until both magnetic moments are aligned parallel to the external magnetic field, when a saturation magnetic field Hs is reached. Hence, for a magnetic field H in the range between a vanishing external field (H=0) and the saturation magnetic field Hs, the resulting overall magnetization m is a result of adding up the associated magnetization vectors m1 and m2, hence, taking an angle enclosed between the two magnetizations into account. When the external magnetic field surpasses the saturation magnetic field Hs, the two magnetizations of the two magnetic layers 220 are aligned parallel so that the overall magnetization is equal to the sum of m1 and m2 (m=m1+m2).

In other words, the magnetization process is accomplished by turning the magnetizations of the individual magnetization layers 220. The saturation magnetic fields Hs can be tuned by varying the thicknesses of the magnetic layers 220 and the non-magnetic layers 240 over a large range of magnetic fields, ranging, for instance, from approximately 0 T to 0.5 T.

While FIG. 3 shows the re-magnetization of the synthetic antiferromagnet 210 shown in FIG. 2, for only two magnetic layers 220-1, 220-2, the magnetic moment or magnetization of the core structure 110 may be increased by repeating the layer system ferromagnet-non-magnetic layer-ferromagnet. In between the previously mentioned layer systems, an insulator may be deposited (e.g., by a sputtering deposition process) to minimize losses due to eddy currents induced by a changing or alternating external magnetic field. Hence, the structure of the synthetic antiferromagnet 210 shown in FIG. 2 may be vertically repeated with insulating layers in between the individual stacks of the two magnetization layers 220 and the non-magnetic layers 240.

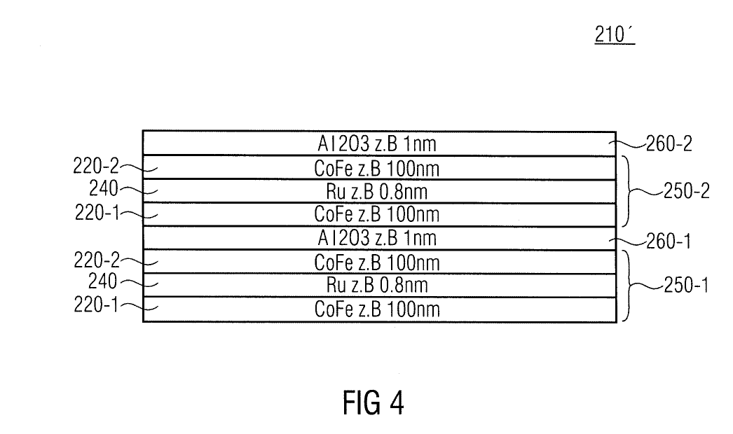

FIG. 4 shows a cross-sectional view of such a synthetic antiferromagnet 210′ according to an embodiment of the present invention. However, before describing the inner structure of the synthetic antiferromagnet 210′, it should be noted that, for the sake of simplicity, same or identical reference signs will be used for same or similar objects. Moreover, two objects being designated by the same reference sign may be identically implemented, for instance, with respect to thicknesses, lateral dimensions, material compositions, or other parameters or properties. In the following, summarizing reference signs will also be used for similar or identical objects appearing more than once in a structure according to an embodiment of the present invention, or which differ only slightly from one embodiment to another. Therefore, using summarizing reference signs relates to general properties and features, unless explicitly or implicitly noted otherwise. For instance, when referring in general to a synthetic antiferromagnet 210, the synthetic antiferromagnet 210′ shown in FIG. 4 is also referred to.

The synthetic antiferromagnet 210′ of FIG. 4 is a synthetic antiferromagnet, as previously described. It comprises a first layer system 250-1 and a second layer system 250-2, which are separated from one another by an insulating layer 260-1. On top of the second layer system 250-2 a further insulating layer 260-2 is deposited. The layer systems, 250-1 and 250-2, collectively 250, may, for instance, comprise or be the stack shown in FIG. 2. Each of the two layer systems 250 comprises two magnetic layers 220-1, 220-2 which are separated by a non-magnetic layer 240.

The synthetic antiferromagnet 210′ of FIG. 4 comprises a cobalt/iron layer (CoFe) with a thickness in the range of approximately 10 nm to approximately 500 nm, approximately 50 nm to approximately 300 nm or approximately 75 nm to approximately 150 nm (e.g., approximately 100 nm) for all magnetic layers 220 and a ruthenium layer (Ru) with a thickness in the range of approximately 0.3 nm to approximately 1.5 nm or 0.5 nm to approximately 1.0 nm (e.g., approximately 0.8 nm) as the non-magnetic layer 240. The two insulating layers 260-1, 260-2 comprise an aluminum oxide layer (Al₂O₃) with a thickness in the range of approximately 0.2 nm to approximately 5 nm, approximately 0.5 nm to approximately 2.5 nm or approximately 0.7 nm to approximately 1.5 nm (e.g., approximately 1 nm) each to facilitate electrical insulation to prevent or reduce eddy currents. However, also other thicknesses may be employed, as outlined below.

To be a little more specific, the magnetic layers 220 are composed of a cobalt/iron alloy as a ferromagnetic metal having a chemical composition of Co₉₀Fe₁₀ which offers a high magnetization and a low anisotropy. Since ruthenium (Ru) offers a strong RKKY-coupling, it has been chosen as the non-magnetic material for the synthetic antiferromagnet 210′. The aluminum oxide layer has been chosen to be the insulating layer to reduce eddy currents, since an aluminum oxide layer (Al₂O₃) can be fabricated using different deposition techniques and further offering the possibility of depositing electrically insulating layers with a very limited risk of loop holes and other sources for short circuits.

However, it should be noted that different stacks other than the one shown in FIG. 4 as layered system 250 may be used. Apart from varying the thickness of the magnetic layers 220, the thicknesses of the insulating layers, 260-1 and 260-2, collectively 260, and varying the chemical compositions of the magnetic layer 220, also different materials may be used for the magnetic layers 220, the non-magnetic layers 240, and the insulating layers 260. For instance, instead of cobalt/iron, cobalt, iron, nickel, or nickel/iron may be used as the material for the magnetic layers 220. Instead of ruthenium, copper may be used as a choice for the non-magnetic layers 240. Furthermore, instead of aluminum oxide layers also other insulating materials such as silicon oxide, or silicon nitride may be used as the basis for the insulating layer 260. In yet other words, a great variety of different stacks comprising a synthetic antiferromagnet may be employed.

Naturally, depending on choice of materials, it may be necessary to adapt the thicknesses of the individual layers. For instance, when exchanging the material for the non-magnetic layers 240, it may be advisable to adapt the thicknesses accordingly. In other words, when changing from ruthenium to copper, it may be advisable to increase the thickness of the respective layers 240 from 0.8 nm to approximately 1.0 nm to optimize, at least partially, the antiferromagnetic coupling between the magnetic layers 220.

Needless to say, due to the previously described interaction between the magnetic moments of two magnetic layers 220 being mediated by the (e.g., free) charge carriers of the non-magnetic layer 240, in many embodiments according to the present invention, no further layers may be present between two antiferromagnetically coupled magnetic layers 220. Therefore, apart from the insulating layers 260, typically only a single non-magnetic layer 240 is arranged in between two magnetic layers 220, which are to be antiferromagnetically coupled to one another.

In other words, the thickness of the non-magnetic layer 240 is chosen such that the antiferromagnetic coupling between the neighboring magnetic layers 220 is at least partially optimized in many embodiments according to the present invention. However, this is by far not a requirement.

However, for the sake of completeness, it should also be noted that the magnetic properties of a core structure 110 comprising a synthetic antiferromagnet 210, such as the synthetic antiferromagnet 210′ shown in FIG. 4, may be adjusted by adjusting the properties of the individual properties of the layers, for instance, their thickness. As a consequence, the magnetic saturation field Hs, as well as a saturation magnetization Ms which is present when the external magnetic field, surpasses the saturation field Hs in terms of its absolute value.

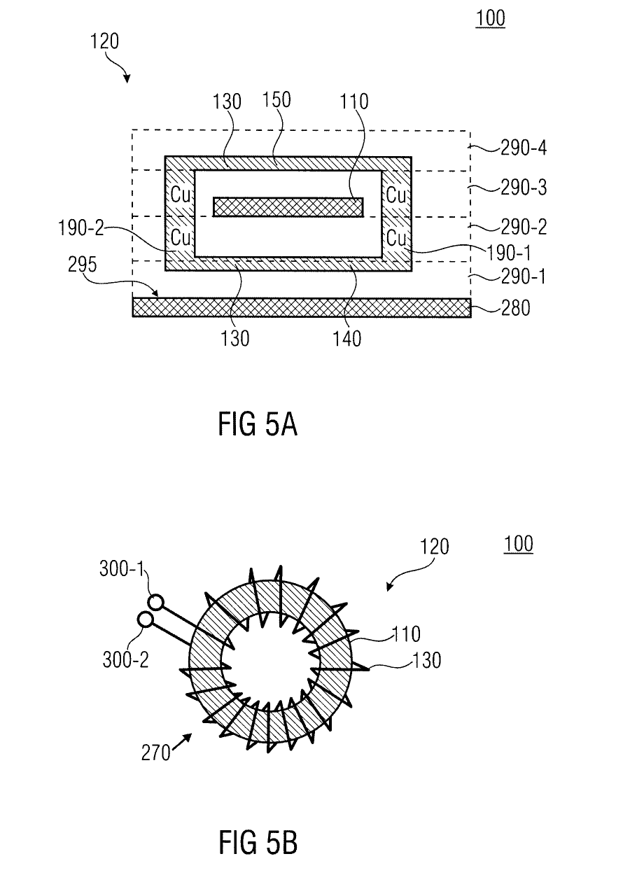

FIGS. 5a and 5b show a further embodiment according to the present invention in the form of an inductor 120 as an example of an inductive electrical device 100. While FIG. 5a once again shows a cross-sectional view of the inductor 120, FIG. 5b shows a top view thereof. In contrast to the cross-sectional views of the inductors 120 of FIGS. 1b and 1c, the cross-sectional view of FIG. 5a is taken along a spiral-like “plane” along a winding as, for example, indicated in FIG. 5b by an arrow 270. The spiral-like cross-section is taken in polar coordinates with respect to a center point, which is not marked as such in FIG. 5a.

The inductor 120 shown in FIG. 5a comprises a substrate, which may be, for instance, a semiconductor substrate (e.g., a silicon substrate (Si)). A first thin film layer 290-1 comprises a first part 140 of a conductive structure 130, which may be fabricated from copper (Cu) to name just one example. Apart from the material of the conductive structure 130, the first thin film layer 290-1 may comprise an electrically insulating material such as aluminum oxide, silicon oxide, or silicon nitride.

On top of the first thin film layer 290-1, a second thin film layer 290-2 is deposited which comprises a lower part of vias 190-1, 190-2 interconnecting the first part 140 of a conductive structure 130 with further parts of the conductive structure 130. On top of the second thin film layer 290-2, a third thin film layer 290-3 is deposited, which not only comprises an upper part of the vias 190-1, 190-2, collectively 190, but also a core structure 110 comprising a synthetic antiferromagnet such as the synthetic antiferromagnets shown in FIGS. 2 and 4.

On top of the third thin film layer 290-3, a fourth thin film layer 290-4 is deposited comprising the upper second part 150 of the conductive structure 130. The conductive structure 130 is electrically insulated from the core structure 110 by the material of the thin film layers 290-1 to 290-4, which may, for example, be silicon oxide (SiO₂), or any other suitable insulating material as the ones previously mentioned.

FIG. 5b shows the corresponding top view of the inductor 120 of FIG. 5a. In contrast to the inductor 120 shown in FIGS. 1a to 1c, the conductive structure 130 forms a plurality of windings around the core structure 110 around its circumference. In other words, to increase the inductance of the inductor 120, the number of windings around the core structure 110 is increased, compared to the inductor 120 shown in FIGS. 1a to 1c. In addition, since the core structure 110 is once again closed, the magnetic flux generated by a current supplied to the conductive structure 130 is “short circuited” by the core structure 110. Since the windings of the conductive structure 130 are distributed around the circumference of the core structure 110, the vias 190, as shown in FIG. 5a, are not required to be essentially perpendicular to a main surface 295 of the substrate 280. In principle, the vias 190 may extend at a certain angle with respect to a normal direction of the substrate 280 being different from zero. As an alternative implementation, the conductive structure 130 may also comprise horizontal sections extending essentially parallel to the extension of the core structure 110.

For the sake of clarity only, FIG. 5b further shows two terminals 300-1, 300-2 of the inductor 120 which may be implemented as vias, electrical conductive structures or the like in a real-life implementation.

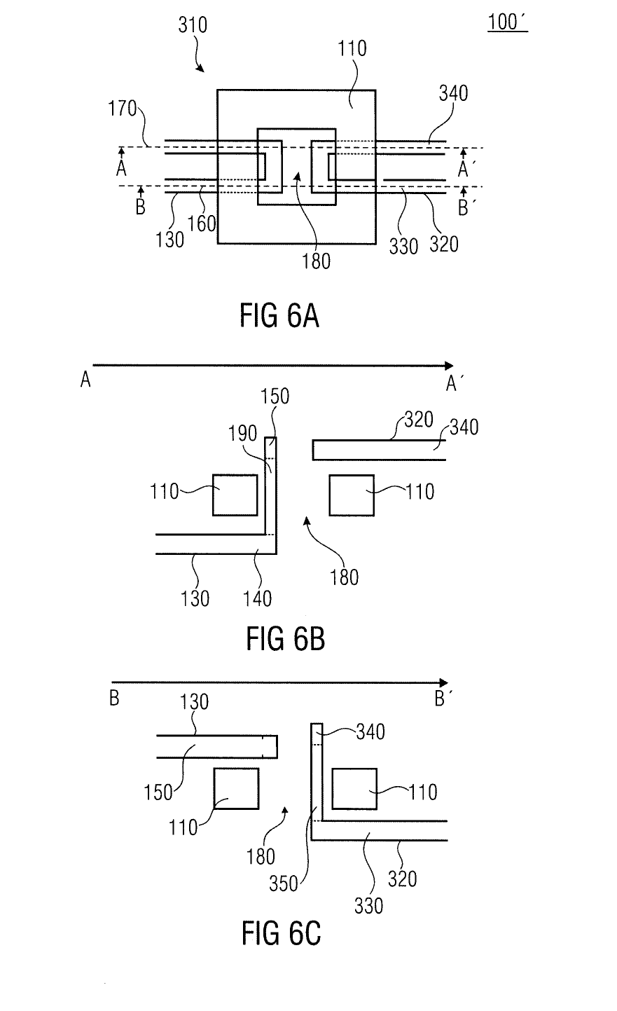

FIGS. 6a to 6c show a further inductive electrical device 100′ according to an embodiment of the present invention, which is similar to the inductive electrical device 100 shown in FIGS. 1a to 1c. As a consequence, reference is hereby made to the description concerning the inductive electrical device 100 shown in the previously mentioned figures.

However, while the inductor electrical device 100 shown in FIGS. 1a to 1c is an inductor 120, the inductive electrical device 100′ shown in FIGS. 6a to 6c is a transformer 310, which differs from the inductor 120 of FIG. 1, mainly with respect to the presence of a further conductive structure 320, which is also electrically insulated from the core structure 110, and also electrically insulated from the conductive structure 130. Similar to the conductive structure 130, also the further conductive structure 320 may comprise a first part 330 arranged in a first layer of the device 100′ and a second part 340 of the further conductive structure 320, arranged in a second layer of a device being different from the first layer.

The two parts 330, 340 may then be electrically connected to one another by a via 350 extending (e.g. essentially vertical) towards the main surface of the substrate (not shown in FIGS. 6a to 6c). However, as outlined in the context of FIGS. 5a and 5b, the vias 350, as well as the vias 190 are not required to be formed essentially vertical with respect to the surface of the substrate (not shown in FIGS. 6a to 6c). In the case of a lateral displacement of parts of the conductive structure 130 and of a further conductive structure 320, the first or second parts of the respective structures may once again comprise essentially horizontally extending sections with respect to the surface of the substrate.

In the case of a single, or even a part of a winding of the conductive structure, or the further conductive structure 320, it may eventually not be necessary to implement a lateral displacement at all. In this case, the first and second parts of the respective conductive structure may extend vertically displaced with respect to the surface of the substrate.

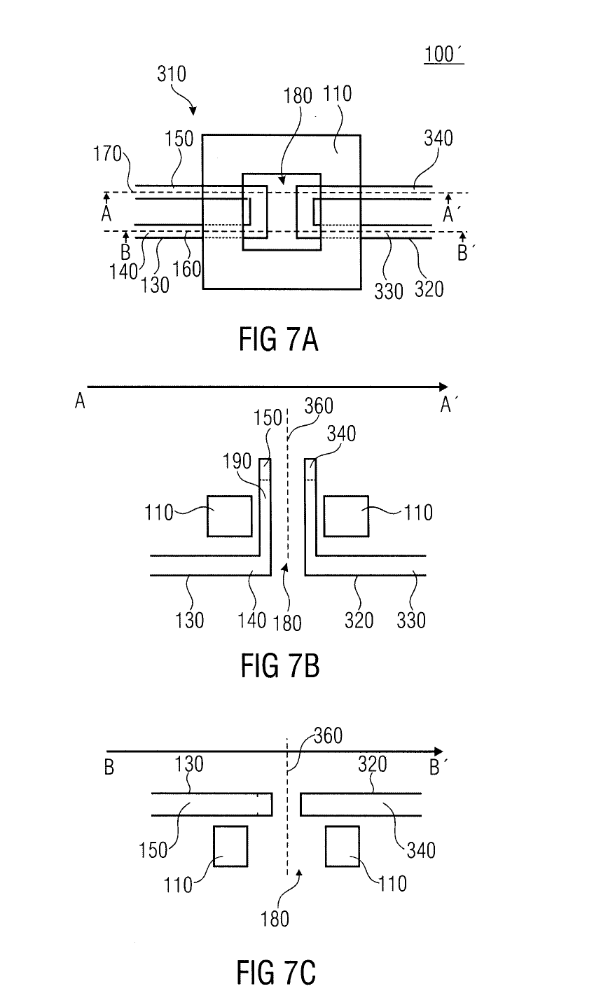

FIGS. 7a to 7c show a further inductive electrical device 100′ according to an embodiment of the present invention in the form of a transformer 310, which differs from the transformer 310 of FIGS. 6a to 6c, mainly with respect to a winding orientation of the further conductive structure 320 with respect to that of the conductive structure 130. The cross-sectional views of the transformer 310 shown in FIGS. 6b and 6c are not symmetrical with respect to the center of the hole 180 in the core structure 110, whereas the cross-sectional views of the transformer 310 shown in FIGS. 7b and 7c are symmetrical with respect to the center line 360 through hole 180 of the core structure 110. Therefore, compared to the transformer 310 of FIGS. 6a to 6c, the winding orientation of the transformer 310 of FIGS. 7a to 7c is opposite, leading to an inversion of the magnetically induced voltages present at the further conductive structure forming the secondary windings of the transformer 310, while the conductive structure 130 forms the primary windings.

The transformers 310 shown in FIGS. 6a to 6c and 7a to 7c are once again based on utilizing synthetic antiferromagnets in the framework of a core structure 110. Hence, synthetic antiferromagnets 210, as shown in FIGS. 2 and 4, may be implemented in the core structures 110.

In further embodiments according to an embodiment of the present invention, transformers 310 may be implemented using different core structures 110. For instance, in contrast to the ring-like shaped ring structures 110 based on rectangular cross-sections as shown in FIGS. 6a to 6c and 7a to 7c, round, ring-shaped core structures 110 may also be implemented. Furthermore, different numbers of windings of the conductive structure 130 forming the primary windings of the transformer 310, and different numbers of windings of the further conductive structure 320 forming the second windings of the transformer 310 may be used, wherein the number of primary windings and secondary windings may be identical or different in the same transformer 310. As a consequence, a wide range of transformers 310 may be implemented allowing an increase, or decrease, of the voltage amplitude, depending on the ratio of the primary windings with respect to the number of secondary windings.

Moreover, in principle the primary and secondary windings are not required to be electrically insulated from one another. Hence, it may be possible to use, for example, a common terminal for the primary and secondary windings such that the conductive structure 130 and the further conductive structure 320 are electrically connected to one another. Furthermore, it is not necessary to implement the previously described transformer 310 on the basis of closed core structures 110.

The previously described modifications also apply to inductors 120 according to embodiments of the present invention. In other words, also in the case of inductors 120 the number of different geometries of the conductive structure 130, its arrangement around the core structure 110, and the different core structures to be implemented with respect to form and material composition, may also be implemented in the case of inductors 120. In addition, in terms of the core structure 110 being closed or partially open, both inductors and transformers may be implemented alike.

As previously mentioned, embodiments according to an embodiment of the present invention in the form of inductive electrical devices 100 are based on using core structures comprising a synthetic antiferromagnet. Due to the previously described physical processes taking place when applying an external magnetic field to the synthetic antiferromagnets 210, a further effect arises. To be more precise, when using a synthetic antiferromagnet as a core structure 110 for an inductor 120 or a transformer 310, magnetic stray fields may be significantly reduced when changing the magnetization, if such stray fields occur at all.

Due to the fact that the magnetic layers 220 are antiferromagnetically coupled inside the synthetic antiferromagnets, the overall magnetization of the synthetic antiferromagnet approximately vanishes in the case of a vanishing external magnetic field. Therefore, it is possible to place the inductive electrical device 100 more freely with respect to further components of a circuit. Since the magnetic performance of the inductive electrical device 100 is far more independent from the features of the closer vicinity of the device 100, it may also be placed on top or below a further circuitry comprised in an integrated circuit. In other words, due to the fact that the core structure 110 comprises a synthetic antiferromagnet, the inductive electrical device 100 may be placed above or below an active area comprising further parts of a circuit.

In the case of inductive electrical devices implementing ferromagnetic cores, the properties of the vicinity of the respective devices play an important role. As a result, placing such an inductive electrical device over or below an active area of an integrated circuit may be very difficult. This in turn increases the necessary chip area and, hence, the costs of a chip comprising such an integrated circuit.

However, due to the fact that by implementing a core structure 110 comprising a synthetic antiferromagnet, it is possible to place the core structure 110 over or below an active area comprising further parts of a circuitry, the previously mentioned increased demand for chip area, as well as the costs resulting therefrom, may be reduced, if not omitted completely.

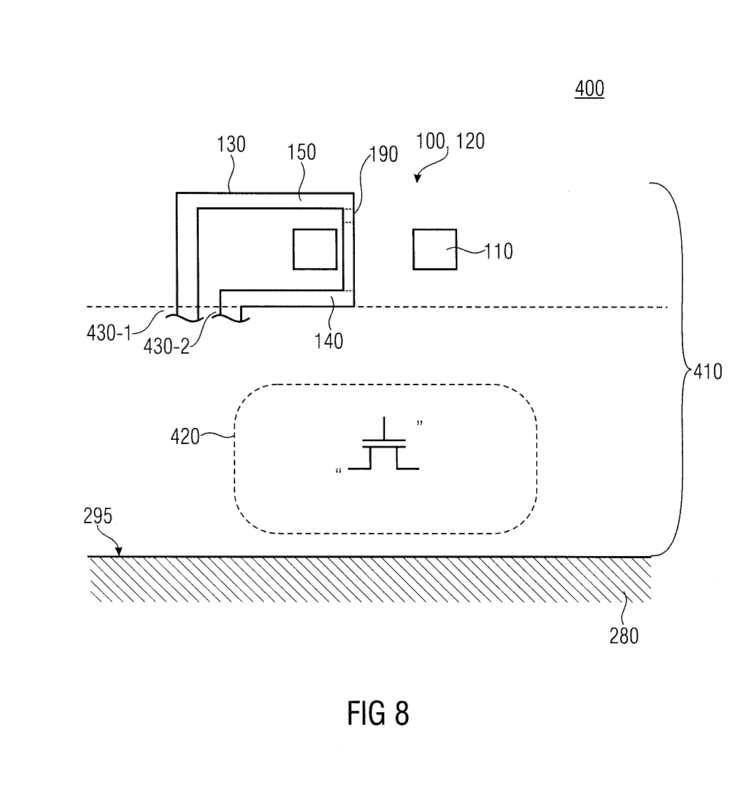

To illustrate this, FIG. 8 shows a cross-sectional view of an integrated circuit 400 comprising an inductive electrical device 100 which is shown in FIG. 8 as an inductor 120. As previously described, the inductor 120 comprises a core structure 110 along with a conductive structure 130, a first part 140 of which is arranged in a first layer, while a second part 150 thereof is located in a second layer, being different from the first layer. The first and second parts 140, 150 of the conductive structure 130 are once again electrically connected by a via 190.

The inductive electrical device 100 in the form of the inductor 120 is comprised in a layered structure 410 which is arranged on a main surface 295 of a semiconductor substrate 280. The layered structure comprises, apart from the inductive electrical device 100, also at least a part of an electrical circuitry 420 which is schematically depicted in FIG. 8 by a circuitry element of a field effect transistor. Apart from parts of a field effect transistor (e.g. gate, source or drain terminals of such a field effect transistor), the further electrical circuitry 420 may also comprise a capacitor or other electrical or electronic components. As schematically depicted in FIG. 8, the inductive electrical device may be coupled to the further circuitry 420 by vias 430-1, 430-2.

In other words, FIG. 8 shows an integrated circuit 400, wherein the inductive electrical device 100, or to be more precise, the core structure 110 thereof is located above or below at least a part of a further circuitry 420. Parts of the circuitry 420, may for example, be part of an oscillatory circuit, the inductor 120 or the inductive electrical device is part of which.

Furthermore, an electrical inductive device 100 may also be implemented below parts of a circuitry inside a substrate 280 or in a layered structure 410. For instance, transistor structures, capacitor structures and the like may be implemented over an inductive electrical device 100. Hence, integrated circuits (IC) according to embodiments of the present invention may also comprise an inductive electrical device 100 underneath a further part of a circuitry.

As outlined before, embodiments according to the present invention may be employed, in principle, in the framework of any circuitry comprising an inductive component, such as oscillatory circuits or the like. Moreover, apart from the already described embodiments, inductive electrical devices 100 may also be implemented as more complex devices, for instance, as inductors or transformers for balun-circuits (BALanced-UNbalanced) having electrically connected first and second conductive structures or more complex formed conductive structures.

While the foregoing has particularly shown and described with reference to particular embodiments thereof, it is to be understood by those skilled in the art that various other changes in the form and details may be made without departing from the spirit and scope thereof. It is to be understood that various changes may be made in adapting to different embodiments without departing from the broader concept disclosed herein and comprehended by the claims that follow.

What is claimed is:

1. An inductive electrical device with a core structure, the core structure comprising a synthetic antiferromagnet.

2. The inductive electrical device according to claim 1, wherein the core structure comprises a closed, ring-like shaped core structure.

3. The inductive electrical device according to claim 1, wherein the inductive electrical structure comprises an inductor or a transformer.

4. The inductive electrical device according to claim 1, further comprising a conductive structure formed at least partially around the core structure, wherein the conductive structure is electrically insulated from the core structure.

5. The inductive electrical device according to claim 4, further comprising a further conductive structure formed at least partially around the core structure and electrically insulated form the core structure.

6. The inductive electrical device according to claim 1, wherein the inductive electrical device is part of a layered structure on a substrate of an integrated circuit.

7. The inductive electrical device according to claim 6, wherein the integrated circuit comprises at least a part of a circuitry above or below the core structure with respect to a main surface of the substrate.

8. The inductive electrical device according to claim 1, wherein the synthetic antiferromagnet comprises at least a first magnetic layer and a second magnetic layer, the first and second magnetic layers being separated by a non-magnetic layer, wherein a thickness of the non-magnetic layer is such that the first magnetic layer comprises a direction of a magnetization being opposite to a direction of the magnetization of the second magnetic layer, when no external magnetic field is present.

9. The inductive electrical device according to claim 1, wherein the synthetic antiferromagnet comprises a plurality of magnetic layers, two neighboring magnetic layers of the plurality of magnetic layers being separated from one another by an insulating layer or by a non-magnetic layer having a thickness such that magnetizations of the two neighboring magnetic layers are aligned in an anti-parallel manner, wherein at least two magnetic layers of the plurality of magnetic layers are only separated by a non-magnetic layer having said thickness.

10. A method of forming an inductive electrical device, the method comprising:
forming a core structure comprising a synthetic antiferromagnet; and
forming a conductive structure, such that the conductive structure is at least partially formed around the core structure.

11. The method according to claim 10, wherein forming the core structure comprises forming at least a first magnetic layer, a second magnetic layer and a conductive non-magnetic layer such that the first and the second magnetic layers are separated by the non-magnetic layer, the non-magnetic layer having a thickness such that a magnetization of the first magnetic layer and a magnetization of the second magnetic layer are oriented in an anti-parallel manner, when no external magnetic field is present.

12. The method according to claim 10, wherein forming the conductive structure comprises forming a first part of the conductive structure in a first layer, forming a second part of the conductive structure in a second layer, wherein the first layer and the second layer are different from one another, and forming a via between the first and second parts of the conductive structure to electrically connect the first part and the second part, wherein the first layer and the second layer are essentially parallel.

13. The method according to claim 10, wherein forming the conductive structure comprises forming the conductive structure such that at least one winding around the core structure is formed.

14. The method according to claim 10, wherein forming the core structure comprises forming the core structure such that the core structure comprises a closed, ring-like shape.

15. The method according to claim 10 further comprising providing an insulating structure between the conductive structure and the core structure such that the conductive structure is electrically insulated from the core structure.

16. The method according to claim 10, further comprising forming a further conductive structure, such that the further conductive structure is at least partially formed around the core structure.

17. The method according to claim 10, wherein the core structure and the conductive structure are formed such that the core structure and the conductive structure are comprised in a layered structure on or part of a semiconductor substrate.

18. An inductor comprising:
a conductive structure; and
a core structure,
wherein the conductive structure forms a winding around the core structure; and
wherein the core structure comprises a synthetic antiferromagnet.

19. The inductor according to claim 18, wherein the conductive structure is a metallic conductor.

20. A transformer comprising:
a first conductive structure;
a second conductive structure; and
a core structure,
wherein the first conductive structure and the second conductive structure each form a winding around the core structure; and
wherein the core structure comprises a synthetic antiferromagnet.

21. The transformer according to claim 20, wherein the first and second conductive structures are a first metallic conductor and a second metallic conductor, respectively.

22. An integrated circuit comprising:
a semiconductor substrate; and
a layered structure over or part of the semiconductor substrate, comprising:
a core structure of an inductive electric device, wherein the core structure comprises a synthetic antiferromagnet;
a conductive structure forming at least partially a winding around the core structure; and
an insulating structure formed to electrically insulate the core structure from the conductive structure,
wherein the core structure comprises a synthetic antiferromagnet.

23. The integrated circuit according to claim 22, wherein the conductive structure comprises a first part in a first layer of the layered structure, a second part in a second layer of the layered structure, and a via electrically connecting the first and the second parts, wherein the first layer is different from the second layer.

24. The integrated circuit according to claim 22, wherein the integrated circuit further comprises a part of electrical circuitry above or below the core structure.

25. The integrated circuit according to claim 22, wherein the layered structure further comprises a further conductive structure forming at least partially a winding around the core structure.
